(19) United States
(12) Patent Application Publication
(10) Pub. No.: US 2013/0145946 A1
(43) Pub. Date: Jun. 13, 2013

(54) METHOD AND ARRANGEMENT FOR REGISTERING COLORS FOR A PRINTING MACHINE

(71) Applicants: Mauro Chiari, Denges (CH); Pierre Gretsch, Valeyres-sous-Ursins (CH); Benoit Rosset, Divonne-les-Bains (FR); Daniel Tatti, Vufflens-la-Ville (CH)

(72) Inventors: Mauro Chiari, Denges (CH); Pierre Gretsch, Valeyres-sous-Ursins (CH); Benoit Rosset, Divonne-les-Bains (FR); Daniel Tatti, Vufflens-la-Ville (CH)

(21) Appl. No.: 13/816,836

(22) PCT Filed: Sep. 20, 2011
(86) PCT No.: PCT/EP2011/004711

§ 371 Date: Feb. 13, 2013

(30) Foreign Application Priority Data
Sep. 21, 2010 (EP) 10010002.3

(51) Int. Cl. B41F 27/00

(52) U.S. Cl. CPC B41F 27/005
USPC 101/481; 101/485

(57) ABSTRACT

A method for registering at least two colors for a machine for printing plate elements equipped with at least two printing units: printing marks of different colors in spaced pairs on edges of the plate elements; detecting position errors between different marks of possibly the same color and comparing the position with respective theoretical relative positions; adjusting operation of the printing units to have both marks of a color overlie.

The present invention relates to a method for automatically registering colors in a machine for printing plate elements. The invention also relates to a color registration arrangement for a machine for printing plate elements. The invention further relates to a printing machine having a color registration arrangement.

A printing machine is used in the packaging industry to print plate elements, such as sheets of paper or cardboard. The machine comprises a plurality of successive stations. A first station situated at the downstream end is an infeed station for inserting sheets successively from the bottom of a stack. The infeed station feeds a plurality of print stations in the form of a printing unit or a succession of printing units. Each printing unit prints one color. At the end of the machine there is provided a delivery station that collects the printed sheets.

In the case of printing sheets of cardboard, the technology employed most frequently is flexographic printing. A printing unit includes a plate cylinder around which is wrapped and on which is tensioned a flexible printing plate. This printing plate prints the sheet after it has been coated with ink by means of a screened roll called an anilox roll and an inker device. The sheet passes between the plate cylinder and a pressure roller. The sheets are transported from one group to another from above by means of a train of rollers and a suction system, which leaves the lower surfaces of the sheets totally free. Given the position of the plate cylinder and the transport means, printing is effected from below the sheets.

Each plate cylinder prints one or more patterns using a different color during each rotation. To obtain a finished image of good quality, it is necessary in particular that all the different color patterns are exactly overlapped. High quality registration is achieved by an operation for registering the colors, optimizing the adjustment of the relative position of the various printing plates on the plate cylinders.

### PRIOR ART

In existing printing machines, the register of these printings is checked by means of register marks printed by each printing roll in the area reserved for quality control signs, i.e. generally in the margin of the sheet. These marks enable determination of the register error of each color relative to a reference color. This operation, known as color registration, is carried out on each change of job.

Numerous known reading systems and vision systems enable detection and reading of these marks printed on the sheets passing in front of a light source. To compensate shifting, the operator inputs a manual correction that is applied to the lateral and/or angular position of the plate cylinders of the corresponding printing units.

A first phenomenon that has to be corrected is a longitudinal shifting of the printing plate on its plate cylinder. A second phenomenon that has to be corrected is a transverse shifting of the printing plate on its plate cylinder. A third phenomenon that has to be corrected is a skewing of the printing plate on its plate cylinder, which is characterized by an askew printing on the sheet. These phenomena may arise in the event of an error of the operator when mounting the printing plate, for example. They may equally occur in the case of an error in the design of the printing plate.

However, such a registration phase necessitates the printing of successive sheets before starting production printing. Each sheet printed is analyzed by the operator, who then adjusts the colors relative to each other by repositioning the printing plate and adjusting the speed of the plate cylinder. On each change of job, this phase takes time during which the machine is not in production. This phase is costly in terms of the ink consumed and the number of sheets used and then rejected after examination by the operator.

The document EP-1.693.199 describes a method of correcting a printing length comprising a step of printing an element with a plurality of printing units and a step of detecting register marks. The positions of the various register marks are determined relative to the edge of the element and the printing length is corrected automatically when the position of a mark deviates relative to the edge.

However, the accuracy of registration correction with such a method depends on detecting the edge of the printed element. If the quality is not high, especially in terms of accurate cutting of the edge, then the correction is insufficient. Moreover, correction accuracy depends on the distance between the edge and the printed register mark. The mark is printed in an area of the element outside the main printed image and constituting waste. Nevertheless, this distance is reduced by the presence of the image situated primarily at the center of the element. With an area of the element outside the image having a small surface, the distance is small and consequently the accuracy is low.

The document U.S. Pat. No. 6,553,906 describes a method of detecting a register deviation on a printed element. One step consists in detecting at least one printed registration mark that is associated with one color relative to at least one other printed registration mark that is associated with another color. The marks are detected with a densitometer by virtue of their superimposition. Register errors are detected if the marks are shifted relative to each other in only one direction.

This type of detection method necessitates a specific detection device. Moreover, detecting different register errors necessitates printing the marks with a plurality of different orientations. Printing all these marks requires space in an area of the element outside the main printed image constituting waste.

### STATEMENT OF THE INVENTION

A principal objective of the present invention consists in developing a method enabling registration of a plurality of colors in a machine for printing plate elements. A second objective is to enable calibration of a printing machine by a simple and fast automatic method. A third objective is to reduce the time to adjust a printing machine and the number of plate elements printed for that adjustment. A fourth objective is to implement a method for registering colors thanks to a specific arrangement. A fifth objective is to avoid the drawbacks of the prior art methods and arrangements. A further objective is to succeed in adjusting a machine by simplifying the work of the operator before starting production printing.

A method for registering at least two colors for a machine for printing plate elements equipped with at least two printing units, the method comprising the steps of:

printing on a plate element a first mark of a first color using a first printing unit,

printing on the plate element a second mark at a distance from the first mark of the first color using the first printing unit,

printing on the plate element a third mark of a second color using a second printing unit,

printing on the plate element a fourth mark at a distance from the third mark of the second color using the second printing unit,

detecting on the printed plate element the first and third marks and the second and fourth marks.

The method according to the invention is characterized in that it comprises the steps of:

determining first position deviations between the first and third printed marks,

comparing the first position deviations with a known position deviation between the first and third marks,

determining second position deviations between the second and fourth printed marks,

comparing the second position deviations with a known theoretical position deviation between the second and fourth marks,

generating an adjustment signal for the second printing unit as a function of the first and second deviations so determined,

adjusting the second printing unit as a function of the signal generated,

so as to register the second color relative to the first color.

Throughout the description, the plate or sheet element is defined, by way of non-comprehensive example, as being in a material such as paper, plate cardboard, corrugated cardboard, corrugated fiberboard, flexible plastic, for example polyethylene (PE), polyethylene terephthalate (PET), bi-oriented polypropylene (BOPP), or other polymers, or other materials having an aptitude for being printed.

The longitudinal and lateral directions are defined with reference to the direction of movement of the plate element along a median longitudinal axis in the machine. The upstream and downstream directions are defined with reference to the direction of movement of the element in the longitudinal direction in the printing machine as a whole. The front, rear and lateral edges of the element are defined with reference to the direction of movement in the longitudinal direction in the printing machine as a whole.

In other words, register errors are corrected by printing two series of marks of different colors at two different places spaced from each other on a single plate element and by providing a step of detecting and comparing these marks for deviations. In order to enable calculation of printed mark position deviations, theoretical predefined positions of the series of marks are known.

The first mark and the second mark serve as reference marks for a single color. The deviations in both dimensions, i.e. the lateral, longitudinal and oblique deviations between the first and second marks of the first color and the third and fourth marks of the second color are calculated. This determines the registration deviations to be corrected by comparison with the theoretical deviations known in advance. Only two series of marks with each of the colors are necessary, taking up little room on the area of the element outside the principal printed image.

The first and second printing units respectively printing the first and second colors are defined as being two different printing units chosen by the operator from those that are available in the printing machine. The same steps of this method are valid for all the other marks with all the other colors by comparison with the first and second marks of the first color. The method finds an application in flexographic or offset printing.

In another aspect of the invention, an arrangement for registering at least two colors for a plate element printing machine is adapted to use the method. In another aspect of the invention, an arrangement registers at least two colors for a plate element printing machine equipped with at least two printing units. The arrangement comprises:

at least one vision system installed downstream of the printing units and adapted to detect on a plate element a first mark printed with a first color, a third mark printed with a second color, a second mark printed with the first color, a fourth mark printed with the second color, and to generate a detection signal; and

a calculation and control unit connected to the vision system and to the printing unit, receiving the signal from the vision system and adapted to determine position deviations between the first and third marks and between the second and fourth marks, to compare them to known theoretical deviations and to generate automatically an adjustment signal for the printing unit to register the second color relative to the first color.

According to a further aspect of the invention, a printing machine comprising at least two printing units is characterized in that it comprises an arrangement for registering at least two colors having one or more of the technical features described hereinafter and claimed.

### BRIEF DESCRIPTION OF THE DRAWINGS

The invention will be better understood and its various advantageous and different features will emerge more clearly from the following description of a nonlimiting embodiment of the invention given with reference to the appended diagrammatic drawings, in which:

FIG. 1 is a synoptic lateral view of a printing machine comprising a registration arrangement of the invention;

FIG. 2 is a view of a printed plate element carrying printing marks in accordance with a first embodiment;

FIG. 3 is a view of a printed plate element carrying printing marks in accordance with a second embodiment; and

FIGS. 4 to 7 are partial views of a printed plate element carrying printing marks in accordance with a third embodiment.

### DETAILED DESCRIPTION OF PREFERRED EMBODIMENTS

As FIG. 1 shows, a printing machine 1, for example a flexo printing machine, comprises:

a frame 2,

an infeed station 3,

five successive printing units 4, 6, 7, 8 and 9 disposed in line to print five different colors, for example black, blue, red, green and yellow, and

a delivery station 11 (represented in dashed outline).

The infeed station 3 receives a stack of plate elements, for example in the form of sheets 12 of corrugated board, free of any printing, and feeds them successively into the first printing unit 4. The delivery station 11 recovers the printed sheets 13. The sheets 12 and 13 circulate from one printing unit to another thanks to trains of upper drive rollers 14 and a series of aspiration means 16.

Each printing unit 4, 6, 7, 8 and 9 comprises an inking device 17 with a bottom ink tank 18, a pump 19, ink circulation means 21 and a chambered doctor blade 22 or an inking roller semi-submerged in an ink pan 23. The inking device enables inking an anilox roll 24. The anilox roll 24 coats with ink a printing plate 26 mounted on a plate cylinder 27.

The printing plate 26 is adjustable on the plate cylinder 27, for example by means of a device such as that described in the document EP-0.972.639, which enables adjustment of position relative to the sheet 12. The plate cylinder 27 is motorized, enabling adjustment of the angular position and/or speed of the printing plate 26 relative to the sheet 12.

In the method of the invention, the registration of the five colors may be adjusted firstly by moving the printing plate 26 to reposition it differently on the plate cylinder 27. This registration of the five colors may equally be adjusted by angularly shifting the plate cylinder 27 to advance or retard it.

The method comprises a plurality of successive steps, including steps of printing register marks on the printed sheets 13 and steps of detecting these marks. The marks are provided from the outset by being included on the printing plates 26 of all the printing units 4, 6, 7, 8 and 9. The method is implemented by a color registration arrangement.

The arrangement comprises a digital video camera type vision system 28 for detecting the register marks. The vision system 28 is installed at the exit from the final printing unit 9, ahead of the delivery station 11.

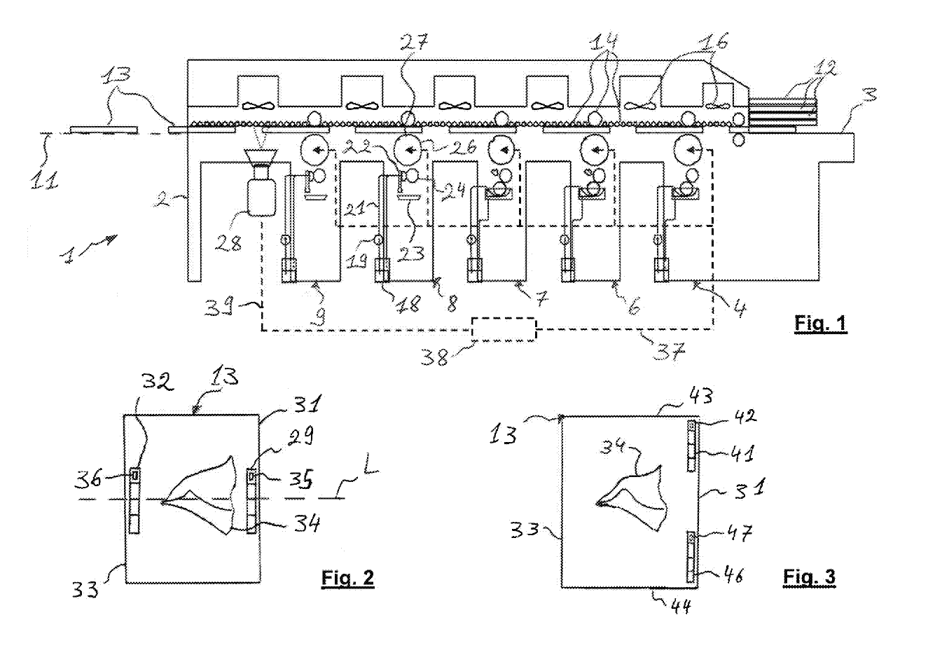

In a first step, a first mark 29 is printed on the sheet 13 by the first printing unit 4. This first mark 29 has a first color, in this case black. In a first preferred embodiment (see FIG. 2), the first mark 29 is printed in the vicinity of a first edge, in this case the front edge 31 of the sheet 13. This first color of the mark 29 serves as a reference.

In a second step, a second mark 32 identical to the first mark 29 is printed on the sheet 13, again by the first printing unit 4. This second mark 32 is therefore black. The second mark 32 is at a distance from the first mark 29. In this first embodiment, the second mark 32 is printed in the vicinity of a second edge, in this case the rear edge 33 of the sheet 13. The black second mark 32 also serves as a reference.

In the first embodiment (FIG. 2) and in a second embodiment (FIG. 3) the choice has been made to give the first mark 29 and the second mark 32 strictly identical shapes, in this case a calibrated grid shape. The grid is defined as a cross-ruled array with a plurality of boxes with predetermined dimensions. The registration of the second color (blue) and the subsequent other colors (red, green and yellow) is adjusted relative to the first color (black). The first mark 29 on the front edge 31 and the second mark 32 on the rear edge 33 are printed in addition to the black pattern of the finished image 34 nearer the middle of the sheet 13.

In a third step, a third mark 35 is printed on the sheet 13 by the second printing unit 6. This third mark 35 has a second color, in this case blue. In this first embodiment, the third mark 35 is printed in the vicinity of the front edge 31. The third mark 35 is printed in the vicinity of the first mark 29. An existing theoretical relative position between the first mark 29 and the third mark 35 is known, being provided from the outset when producing the printing plate 26.

In a fourth step, a fourth mark 36 is printed on the sheet 13 by the second printing unit 6. This fourth mark 36 is therefore blue. The fourth mark 36 is at a distance from the third mark 35. In this first embodiment, the fourth mark 36 is printed in the vicinity of the rear edge 33. The fourth mark 36 is printed in the vicinity of the second mark 32. An existing theoretical relative position between the second mark 32 and the fourth mark 36 is known, being provided from the outset when producing the printing plate 26.

In the first embodiment (FIG. 2) and in the second embodiment (FIG. 3) the choice has been made to give the third mark 35 and the fourth mark 36 strictly identical shapes, in this case a square shape. When the first and second colors are in register, the square of the third mark 35 coincides perfectly with the grid of the first mark 29 and the square of the fourth mark 36 coincides perfectly with the grid of the second mark 32, being disposed at the center of the corresponding box. The third mark 35 on the front edge 31 and the fourth mark 36 on the rear edge 33 are printed in addition to the blue pattern of the finished image 34 nearer the middle of the sheet 13.

In a fifth step, the vision system 28 detects the first mark 29 and the third mark 35 in the vicinity of the front edge 31 and the second mark 32 and the fourth mark 36 in the vicinity of the rear edge 33.

The marks 29, 32, 35 and 36 are printed in the vicinity of substantially the same longitudinal line, which in this case is a median longitudinal line L of the sheet 13. Given that the marks 29, 32, 33 and 35 are printed at the front and rear edges 31 and 33 and centered relative to the sheet 13, the vision system 28 is installed on the median longitudinal axis of the machine 1. A single system 28 is needed for scanning a small area, which enables reduction of costs.

In a sixth step, position deviations between the first mark 29 and the third mark 35 in the vicinity of the front edge 31 are determined. These position deviations are compared with the known theoretical relative position of the first mark 29 and the third mark 35. Position deviations between the second mark 32 and the fourth mark 36 in the vicinity of the rear edge 33 are determined. These position deviations are compared with the known theoretical relative position of the second mark 32 and the fourth mark 36.

In a seventh step, an adjustment signal 37 for the second printing unit 6 is automatically generated as a function of the deviations determined and compared in the sixth step.

In an eighth step, the second printing unit 6 is adjusted as a function of the generated adjustment signal 37. The blue color printed by the second printing unit 6 is registered with the black color printed by the first printing unit 4.

The color registration arrangement comprises a calculation and control unit 38 implementing the sixth and seventh steps of the method. The unit 38 is electrically connected to the vision system 28 and to the printing units 4, 6, 7, 8 and 9. The calculation and control unit 38 receives a detection signal 39 from the vision system 28 and consequently generates the adjustment signal 37 automatically.

A first type of adjustment signal 37 comprises a signal for adjusting the position of the printing plate 26 on the plate cylinder 27 of the second printing unit 4. A second type of adjustment signal 37 comprises a signal for adjusting the speed and the angular position of the plate cylinder 27 of the second printing unit 4.

These steps of the method for registering the first color with the second color are applied in an analogous manner to register the first color with the third color (red) printed by the third printing unit 7, the fourth color (green) printed by the fourth printing unit 8 and the fifth color (yellow) printed by the fifth printing unit 9.

In the second embodiment (see FIG. 3), the first mark 41 and the third mark 42 are printed in the vicinity of a first edge 43 that is one of the lateral edges of the sheet 13. The second mark 44 and the fourth mark 46 are printed in the vicinity of a second edge 47 that is the other of the lateral edges of the sheet 13. These marks 41, 42, 44 and 46 are also in the vicinity of the front edge 31 of the sheet 13. In a manner analogous to that of the first embodiment (FIG. 2), the choice has been made to give the first mark 29 and the second mark 32 strictly identical calibrated grid shapes. The choice has been made to give the third mark 35 and the fourth mark 36 strictly identical square shapes.

Given that the marks 41, 42, 44 and 46 are printed at the lateral edges 43 and 47 of the sheet 13, two vision systems 28 are installed one on each side of the passage of the sheets 13 at the lateral edges 43 and 47.

In a third embodiment (see FIGS. 4 to 7), and in a manner analogous to that of the first embodiment, the first mark 29 is printed in the vicinity of the front edge 31 of the sheet 13. This first color mark 29 serves as a reference. The second mark 32 is printed in the vicinity of the rear edge 33 of the sheet 13. This second mark 32 also serves as a reference. The third mark 35 is printed in the vicinity of the front edge 31. The third mark 35 is printed in the vicinity of the first mark 29. The fourth mark 36 is printed in the vicinity of the rear edge 33. The fourth mark 36 is printed in the vicinity of the second mark 32.

An existing theoretical relative position between the first mark 29 and the third mark 35 is known, being provided from the outset when producing the printing plate 26 (see the dashed lines in FIGS. 4 to 7). An existing theoretical relative position between the second mark 32 and the fourth mark 36 is known, being provided from the outset when producing the printing plate 26 (see dashed lines in FIGS. 4 to 7).

In this third embodiment, the choice has been made to give all the marks 29, 32, 35 and 36 strictly identical shapes, in this case a round shape. The marks 29, 32, 35 and are printed in the vicinity of substantially the same longitudinal line, which in this case is the median longitudinal line L of the sheet 13. The third mark 35 and the fourth mark 36 are on the median longitudinal line L.

As may be seen in FIG. 4, the marks 29, 32, 35 and 36 are detected as being at their reference position. There is no lateral, longitudinal or oblique error. No registration correction is necessary.

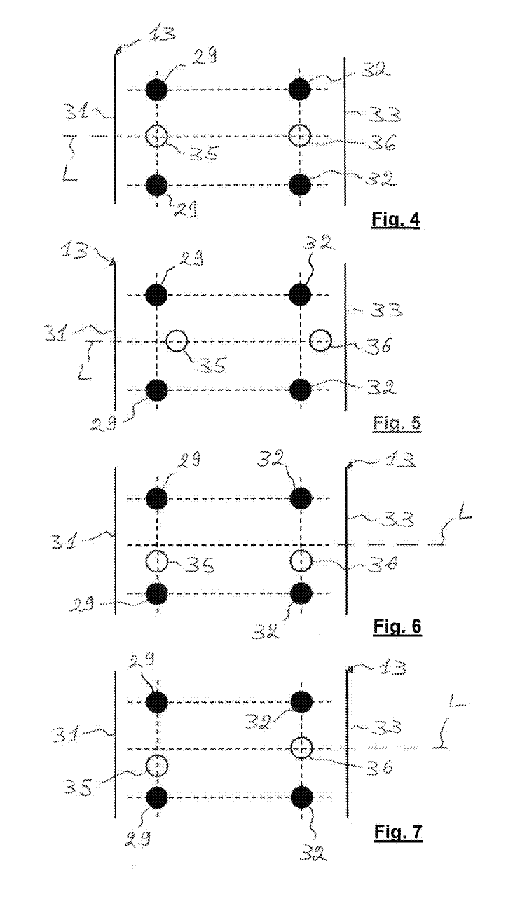

As may be seen in FIG. 5, there is no lateral error and no oblique error. A longitudinal error is detected, the third mark 35 and the fourth mark 36 both being shifted toward the rear edge 33 of the sheet 13. The arrangement registers the second color by correcting the angular position of the plate cylinder 27.

As may be seen in FIG. 6, there is no longitudinal error and no oblique error. A lateral error is detected, the third mark 35 and the fourth mark 36 being both shifted toward one of the lateral edges of the sheet 13. The arrangement registers the second color by correcting the lateral position of the printing plate 26 on its plate cylinder 27.

As may be seen in FIG. 7, there is no lateral error and no longitudinal error. An oblique error is detected, only the third mark 35 being shifted toward one of the lateral edges of the sheet 13. The arrangement registers the second color by correcting the oblique position of the printing plate 26 on its plate cylinder 27.

All cases of combinations of lateral errors, longitudinal errors and oblique errors for all colors may be corrected using the method and the arrangement of the invention.

The present invention is not limited to the embodiments described and shown. Numerous modifications may be made without departing from the scope of the invention defined by the claims.

1. A method for registering at least two colors for a machine for printing plate elements, the machine being equipped with at least two printing units for printing the plate elements, the method comprising the steps of:
printing on a plate element a first mark of a first color using a first printing unit;
printing on the plate element a second mark at a distance from the first mark also of the first color and also using the first printing unit;
printing on the plate element a third mark of a second color using a second printing unit;
printing on the plate element a fourth mark at a distance from the third mark also of the second color and also using the second printing unit;
detecting on the plate element the first and third marks and the second and fourth marks;
determining first position deviations between the first and third printed marks and comparing the first determined deviation with a known first theoretical position deviation between the first and third marks, determining second position deviations between the second and fourth printed marks and comparing the second determined deviation with a known second theoretical position deviation between the second and fourth marks;
generating an adjustment signal for the second printing unit as a function of the deviations so determined, wherein the signal is for adjusting the second printing unit as a function of the adjustment signal generated so as to register the second color relative to the first color on the plate elements.

2. A method according to claim 1, wherein the first and third marks are printed in the vicinity of a first edge of the plate element and the second and fourth marks are printed in the vicinity of a second edge of the plate element.

3. A method according to claim 1, wherein the first edge is a front or leading edge and the second edge is a rear or trailing edge of the plate element, and also printing the marks in the vicinity of substantially the same longitudinal line.

4. A method according to claim 2, wherein the first edge and the second edge are both lateral edges of the plate element.

5. A method according to claim 1, wherein the signal generated causes a position adjustment of a printing plate on a plate cylinder of the second printing unit.

6. A method according to claim 5, wherein the position adjustment is effected laterally.

7. A method according to claim 5, wherein the position adjustment is a skew adjustment.

8. A method according to claim 1, wherein the signal generated causes an adjustment of the speed and/or the angular position of a plate cylinder of the second printing unit.

9. A method according to claim 1, wherein the marks have a circle shape.

10. A method according to claim 1, wherein the first and second marks have the shape of a grid inside which the third and fourth marks, respectively, are printed.

11. An arrangement for registering at least two colors for a machine for printing plate elements, the machine comprising at least two printing units in succession along a path of the plate elements;
the arrangement comprising:
at least one vision system installed downstream of the at least two printing units and located and configured to detect the presence on a plate element of a first printed mark of a first color, a third printed mark of a second color, a second printed mark of the first color, a fourth printed mark of the second color, and to generate a detection signal of the printed marks selected; and
a calculation and control unit connected to the vision system and to the printing unit, the unit receiving the signal from the vision system and being configured to determine position deviations between the first and third marks and between the second and fourth marks, and to compare the deviations to known theoretical deviations and to generate automatically an adjustment signal for the printing unit so as to register the second color relative to the first color.

12. An arrangement according to claim 11, wherein the vision system is mounted downstream of the printing units.

13. An arrangement according to claim 12, wherein the vision system is positioned on the median longitudinal axis of the machine.

14. Arrangement according to claim 11, further comprising two of the vision systems, positioned one on each lateral side of the passage of the plate elements and each at one of the lateral edges of the elements.

15. A printing machine comprising at least two printing units and an arrangement according to claim 11 for registering at least two colors on the plate elements.
